(19) United States
(12) Patent Application Publication
(10) Pub. No.: US 2017/0178046 A1
(43) Pub. Date: Jun. 22, 2017

(54) DETERMINING AN AVERAGE OF PERFORMANCE METRICS WITHOUT SHARING ACTUAL PERFORMANCE METRICS

(71) Applicant: International Business Machines Corporation, Armonk, NY (US)

(72) Inventors: Supriyo Chakraborty, White Plains, NY (US); Dinesh C. Verma, New Castle, NY (US)

(21) Appl. No.: 14/974,781

(22) Filed: Dec. 18, 2015

(51) Int. Cl. G06Q 10/06; H04L 29/06

(52) U.S. Cl. CPC G06Q 10/06393; H04L 67/42

(57) ABSTRACT

A respective obfuscated performance metric can be received from each of a plurality of client devices. The respective obfuscated performance metrics can be aggregated and an average of the aggregated obfuscated performance metrics can be determined. The average of the obfuscated performance metrics can be communicated to at least a first of the plurality of client devices as representing an average of actual performance metrics.

### BACKGROUND

The present invention relates to computing systems, and more specifically, to computing systems which generate performance metrics.

Key performance indicators (KPIs) are a set of indicators including data that can be measured to gauge performance of an organization. Examples of KPIs include, but are not limited to, net revenue, customer satisfaction metrics, customer loyalty metrics, operational efficiency, and the like. It is common for organizations to use KPIs to evaluate various factors that are crucial to their success. For instance, an organization may apply KPIs to business intelligence in order to gauge business trends, assess progress toward achieving declared goals, and advise tactical courses of action.

### SUMMARY

A method includes receiving from each of a plurality of client devices a respective obfuscated performance metric. The method also can include aggregating the respective obfuscated performance metrics and determining, using a processor, an average of the aggregated obfuscated performance metrics. The method also can include communicating to at least a first of the plurality of client devices the average of the obfuscated performance metrics as representing an average of actual performance metrics.

A system includes a processor programmed to initiate executable operations. The executable operations include receiving from each of a plurality of client devices a respective obfuscated performance metric. The executable operations also can include aggregating the respective obfuscated performance metrics and determining an average of the aggregated obfuscated performance metrics. The executable operations also can include communicating to at least a first of the plurality of client devices the average of the obfuscated performance metrics as representing an average of actual performance metrics.

A computer program includes a computer readable storage medium having program code stored thereon. The program code is executable by a processor to perform a method. The method includes receiving, by the processor, from each of a plurality of client devices a respective obfuscated performance metric. The method also can include aggregating, by the processor, the respective obfuscated performance metrics and determining, by the processor, an average of the aggregated obfuscated performance metrics. The method also can include communicating, by the processor, to at least a first of the plurality of client devices the average of the obfuscated performance metrics as representing an average of actual performance metrics.

### BRIEF DESCRIPTION OF THE DRAWINGS

FIG. 1 is a block diagram illustrating an example of a computing environment.

FIG. 2 is a flowchart illustrating an example of a process implemented by an executable function to generate an obfuscated performance metric.

FIG. 3 is a flowchart illustrating an example of a method of communicating to at least one client device an average of obfuscated performance metrics.

FIG. 4 is a block diagram illustrating an example architecture for a performance metrics server.

FIG. 5 is a block diagram illustrating an example architecture for a client device.

### DETAILED DESCRIPTION

This disclosure relates to computing systems, and more specifically, to computing systems which generate performance metrics. In accordance with the inventive arrangements disclosed herein, each of a plurality of client devices can generate obfuscated performance metrics. For example, the client devices can change actual performance metrics in accordance with a suitable executable function to generate the obfuscated performance metrics. Each client device can communicate the obfuscated performance metrics to a server, which can aggregate the obfuscated performance metrics and generate an average of the obfuscated performance metrics. Since the received obfuscated performance metrics can be changed using an executable function, with some being higher and some being lower than the actual performance metrics, the average of the obfuscated performance metrics can be substantially close to an average of the actual performance metrics. In other words, differences between actual performance metrics and obfuscated performance metrics can be canceled out when the obfuscated performance metrics are averaged.

The server can communicate to the client devices the average of the obfuscated performance metrics. The client devices can compare respective actual performance metrics to the average of the obfuscated performance metrics to gauge performance of respective organizations at achieving a particular desired goal. Because the server receives obfuscated performance metrics, the server need not have knowledge of the actual performance metrics. Thus, organizations can be assured that their actual performance metrics remain confidential.

Several definitions that apply throughout this document now will be presented.

As defined herein, the term “actual performance metric” means at least one value indicating a performance of an organization toward achieving a desired goal. An example of an actual performance metric is an actual key performance indicator (KPI).

As defined herein, the term “obfuscated performance metric” means at least one value generated by changing at least one value of an actual performance metric to conceal the true value of the actual performance metric. An example of an obfuscated performance metric is an obfuscated KPI.

As defined herein, the term “substantially close” means within a particular tolerance. For example, an average of obfuscated performance metrics that is substantially close to an average of actual performance metrics can be within 1%, 2%, 3%, 4% or 5% of the average of actual performance metrics. The average of actual performance metrics need not be determined in order to generate an average of obfuscated performance metrics that is substantially close to an average of actual performance metrics. Instead, one or more suitable executable functions can be applied to generate the obfuscated performance metrics to ensure that the average of the obfuscated performance metrics will be substantially close to the average of actual performance metrics.

As defined herein, the term “server” means a processing system including at least one processor and memory that provides services to a plurality of client devices.

As defined herein, the term “client device” means a processing system including at least one processor and memory that requests services provided by a server. Examples of a client device include, but are not limited to, a workstation, a desktop computer, a mobile computer, a laptop computer, a netbook computer, a tablet computer, a smart phone, a personal digital assistant, a smart watch, smart glasses, a set-top box, and the like. Another example of a client device is a client side server that is distinct from another server from which the client side server requests services. Network infrastructure, such as routers, firewalls, switches, and the like, are not client devices as the term “client device” is defined herein.

As defined herein, the term “responsive to” means responding or reacting readily to an action or event. Thus, if a second action is performed “responsive to” a first action, there is a causal relationship between an occurrence of the first action and an occurrence of the second action, and the term “responsive to” indicates such causal relationship.

As defined herein, the term “computer readable storage medium” means a storage medium that contains or stores program code for use by or in connection with an instruction execution system, apparatus, or device. As defined herein, a “computer readable storage medium” is not a transitory, propagating signal per se.

As defined herein, the term “processor” means at least one hardware circuit (e.g., an integrated circuit) configured to carry out instructions contained in program code. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, the term “real time” means a level of processing responsiveness that a user or system senses as sufficiently immediate for a particular process or determination to be made, or that enables the processor to keep up with some external process.

As defined herein, the term “output” means storing in memory elements, writing to display or other peripheral output device, sending or transmitting to another system, exporting, or the like.

As defined herein, the term “automatically” means without user intervention.

As defined herein, the term “user” means a person (i.e., a human being).

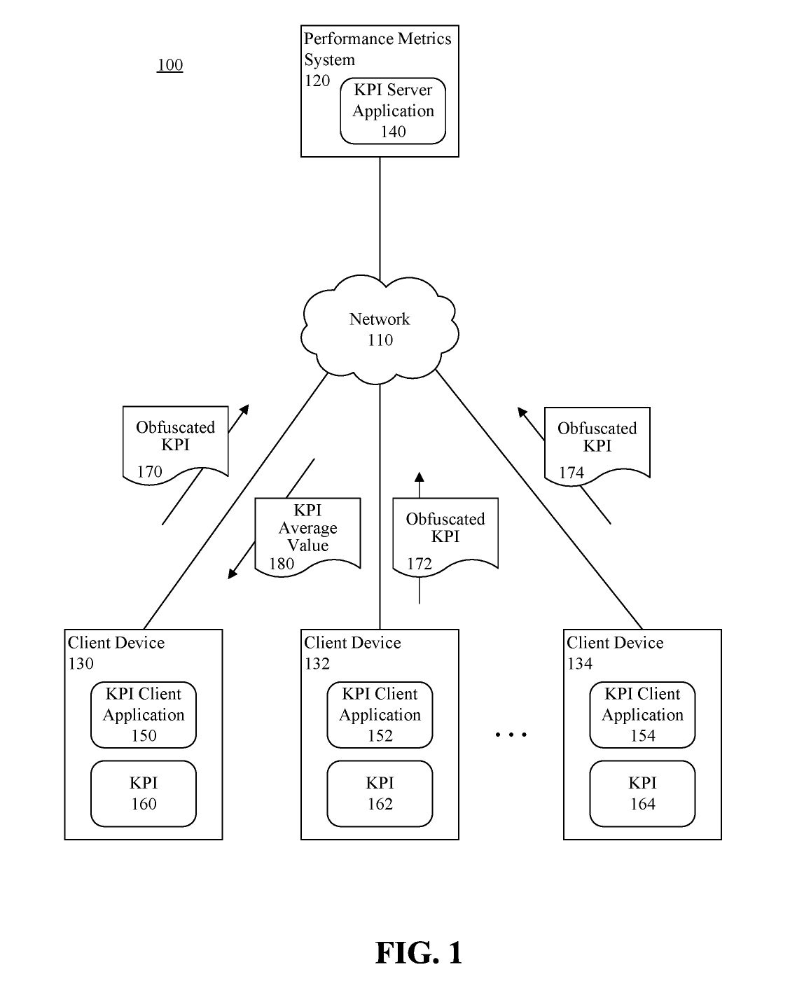

FIG. 1 is a block diagram illustrating an example of a computing environment 100 in which the present arrangements may be implemented. The computing environment 100 can contain a network 110. The network 110 is the medium used to provide communications links between various devices and data processing systems connected together within the computing environment 100. The network 110 may include connections, such as wire, wireless communication links, or fiber optic cables. The network 110 may be implemented as, or include, any of a variety of different communication technologies such as a Wide Area Network (WAN), a Local Area Network (LAN), a wireless network, a mobile or cellular network, a Virtual Private Network (VPN), the Internet, the Public Switched Telephone Network (PSTN), or the like.

In the depicted example, a performance metrics system 120 and a plurality of client devices 130, 132, 134 may couple to the network 110. The performance metrics system 120 can be implemented by one or more servers and can include a KPI server application 140 executable by the server(s). Each of the client devices 130, 132, 134 can include a respective KPI client application 150, 152, 154 executable by the respective client device 130-134. The performance metrics system 120 can communicate to the respective client devices 130-134 the KPI client applications 150-154. For example, the client devices 130-134 can download the KPI client applications 150-154 from the performance metrics system 120.

In operation, the KPI client application 150 can receive or generate a performance metric, such as an actual KPI 160. For example, in one arrangement, a user can enter the actual KPI 160 into the KPI client application 150. In another arrangement, the KPI client application 150 can access data records (e.g., database records) and process the data records to generate the actual KPI 160. Responsive to generating or receiving the actual KPI 160, or responsive to a user input, the KPI client application 150 can process the actual KPI 160 to generate an obfuscated KPI 170, and communicate the obfuscated KPI 170 to the performance metrics system 120 via the network 110. Further, the KPI client application 152 can receive and process an actual KPI 162 to generate an obfuscated KPI 172 in a similar manner, and communicate the obfuscated KPI 172 to the KPI server application 140. Also, the KPI client application 154 can receive and process an actual KPI 164 to generate an obfuscated KPI 174 in a similar manner, and communicate the obfuscated KPI 174 to the KPI server application 140.

To generate the obfuscated KPI 170, the KPI client application 150 can process the actual KPI 160 using one or more suitable executable functions to change one or more values of the actual KPI 160. By way of example, the KPI client application 150 can communicate a request to the KPI server application 140 requesting KPI services. Responsive to receiving the request, the KPI server application 140 can select one or more executable functions and/or parameters to be used by one or more executable function(s) to generate the obfuscated KPI 170 to have a value within a particular variance of the actual KPI 160. The KPI server application 140 can communicate the executable function(s) and/or parameters to the KPI client application 150. Using the executable function(s) and/or parameter(s) received from the KPI server application 140, the KPI client application 150 can generate the obfuscated KPI 170 by processing the actual KPI 160.

In one arrangement, the KPI server application 140 can communicate to the KPI client application 150 executing on the client device 130 one or more parameters. The parameters can, for example, define a lower range and an upper range of variance of the obfuscated KPIs 170-174 from the actual KPIs 160-164. For example, the parameters can define a random noise vector from a Gaussian distribution. The KPI client application 150 can input the parameters into an executable function used to generate a random value, which may be a positive or negative value. The KPI client application 150 can execute the function to generate the random value, and add the random value to the actual KPI 160 to generate the obfuscated KPI 170 having a variance from the actual KPI 160 that corresponds to the received parameters. The function may access a random number generator to facilitate generation of the random value using the provided parameters. The KPI client applications 152, 154 executing on the client device 132, 134 can generate the obfuscated KPIs 172, 174, respectively, in a similar manner.

In another arrangement, the KPI server application 140 can communicate to the KPI client application 150 executing on the client device 130 a plurality of parameters. A first parameter can be configured to result in the obfuscated KPI 170 having a value 35% lower than the actual KPI 160, a second parameter can be configured to result in the obfuscated KPI 170 having a value 30% lower than the actual KPI 160, a third parameter can be configured to result in the obfuscated KPI 170 having a value 25% lower than the actual KPI 160, and so on, up through a parameter that is configured to result in the obfuscated KPI 170 having a value 35% higher than the actual KPI 160. The KPI client application 150 can randomly select at least one of the parameters. The KPI client application 150, however, need not indicate to the KPI server application 140 which parameter(s) is/are selected. The KPI client application 150 can input the randomly selected parameter(s) into an executable function used to generate the obfuscated KPI 170. The executable function can be received from the KPI server application 140 to generate the obfuscated KPI 170 or can be an executable function that is stored on the client device 130 a priori, for example as a component of the KPI client application 150. The KPI client application 150 can perform the executable function on the actual KPI 160 using the randomly selected parameter to generate the obfuscated KPI 170 having a variance from the actual KPI 160 that corresponds to the selected parameter. The KPI client applications 152, 154 executing on the client device 132, 134 can generate the obfuscated KPIs 172, 174, respectively, in a similar manner.

In another arrangement, the KPI server application 140 can communicate to the KPI client application 150 a plurality of different executable functions, and the KPI client application 150 can randomly select one or more of the executable functions to use to generate the obfuscated KPI 170. In this regard, each executable function can be configured to provide a different variance of the obfuscated KPI 170 from the actual KPI 160, and the KPI client application 150 need not indicate to the KPI server application 140 which executable function(s) is/are selected. The KPI client application 150 can execute the randomly selected executable function(s) on the actual KPI 160 to generate the obfuscated KPI 170 having a variance from the actual KPI 160 that corresponds to the selected executable function. Again, the KPI client applications 152, 154 executing on the client device 132, 134 can generate the obfuscated KPIs 172, 174, respectively, in a similar manner.

To randomly select parameters and/or executable functions, the KPI client application 150 can associate each received parameter and/or executable function with a respective numerical value. The KPI client application 150 can use a random number generator to generate random numbers. Responsive to the KPI client application 150 identifying the random number generator generating a numerical value, the KPI client application 150 can select the parameter and/or executable function assigned that numerical value. For instance, if there are twenty different parameters available for selection, the KPI client application 150 can configure the random number generator to randomly generate numerical values ranging from one through twenty.

In another arrangement, rather than the client devices 130-134 being tasked with randomly selecting the parameters and/or executable functions, such selection can be performed by the KPI server application 140. For example, responsive to receiving a request from the KPI client application 150 to upload an obfuscated KPI 170, the KPI server application 140 can select at least one parameter and/or executable function to be used to generate the obfuscated KPIs 170, and communicate the selected parameter(s) and/or executable function(s) to the KPI client application 150. The KPI client application 150 can process the actual KPI 160 using the parameter(s) and/or executable function(s) to generate the obfuscated KPI 170. In such an arrangement, the KPI server application 140 need not store a record indicating which parameter(s) and/or executable function(s) were selected and communicated to the KPI client application 150. Thus, the value of the actual KPI 160 can remain confidential. In this arrangement, the KPI server application 140 can implement processes to ensure that the parameter(s) and/or executable function(s) that are sent to the KPI client applications 150-154 result in the variances of the obfuscated KPIs 170-174 from the actual KPIs 160-164 that averages to zero. For example, the parameter(s) and/or executable function(s) can be identified in an ordered list, and the KPI server application 140 can cycle through the ordered list in a particular order to select the parameter(s) and/or executable function(s) as requests from KPI client applications 150-154 are received.

Responsive to the KPI server application 140 receiving the obfuscated KPI 170, the KPI server application 140 can, in real time, aggregate the received obfuscated KPI 170 with previously received obfuscated KPIs 172-174. Further, the KPI server application 140 can, in real time, process the aggregated obfuscated KPIs 170-174 to determine at least one KPI average value 180 for the obfuscated KPIs 170-174 that are aggregated. For example, the KPI server application 140 can determine a mean, median, mode and/or range of the obfuscated KPIs 170-174 that are aggregated. Responsive to determining the KPI average value 180 for the obfuscated KPIs 170-174 that are aggregated, the KPI server application 140 can communicate the KPI average value 180 to the KPI client application 150. The KPI average value 180 can represent an average of the actual KPIs 160-164.

At this point it should be noted that the KPI average value 180 for the obfuscated KPIs 170-174 that are aggregated can be substantially close to an average value of the actual KPIs 160-164, though the average value of the actual KPIs 160-164 need not be determined by the KPI server application 140. In this regard, the obfuscated KPIs 170-174 that are aggregated can include a large data set of obfuscated KPIs 170-174, for example more than ten obfuscated KPIs 170-174, more than one hundred obfuscated KPIs 170-174, or perhaps more than one thousand obfuscated KPIs 170-174. Since the parameters and/or executable functions for generating the obfuscated KPIs 170-174 are randomly selected, or selected in a particular manner, the variances of the obfuscated KPIs 170-174 from the actual KPIs 160-164 can cancel each other when the obfuscated KPIs 170-174 are averaged. For instance, the executable functions and/or parameters used to generate the obfuscated KPIs 170-174 can generate some obfuscated KPIs 170-174 that have values higher than the actual KPIs 160-164, and can generate some obfuscated KPIs 170-174 that have values lower than the actual KPIs 160-164. The mean average of the variances can be equal to zero, or can be close to zero. Thus, by averaging the obfuscated KPIs 170-174, the variances can be rendered insignificant over the entire set of the obfuscated KPIs 170-174 that are aggregated.

Accordingly, the KPI server application 140 can determine the KPI average value 180 for the obfuscated KPIs 170-174, and the determined average can be used to represent the average value of the actual KPIs 160-164 without the KPI application server application 140 ever receiving the actual KPIs 160-164. Thus, organizations using services provided by the KPI server application 140 need not provide to the KPI server application 140 their actual KPIs 160-164. This ensures that organizations can keep their actual KPIs 160-164 confidential. Nonetheless, the organizations still can benefit by receiving the KPI average value 180 and processing the KPI average value 180 for internal use.

In illustration, responsive to receiving the KPI average value 180, the KPI client application 150 can compare the actual KPI 160 to the KPI average value 180, and output an indicator indicating how the actual KPI 160 compares to the KPI average value 180. By way of example, assume the actual KPIs 160-164 include values corresponding to customer satisfaction in a particular industry, for instance based on a rating from 0 to 10. If the KPI average value 180 indicates an average customer rating of 7.2 and the actual KPI 160 indicates a customer rating for an organization of 7.6, the KPI client application 150 can output the average customer rating and an indicator that indicates that organization's customer satisfaction is 5.5% higher than the average customer rating in that industry.

In another example, the KPI server application 140 can determine a relative ranking of the obfuscated KPI 170 in comparison to other obfuscated KPIs 172, 174, and communicate to the KPI client application 150 an indication of such ranking. For instance, the KPI server application 140 can communicate to the KPI client application 150 an ordered list including each of the obfuscated KPIs 170-174, and each obfuscated KPI 170-174 can be located in the ordered list according to its ranking. The KPI server application 140 also can communicate the ordered list to the KPI client applications 152, 154. Such rankings can be substantially close to the rankings of the actual KPIs 160-164. Nonetheless, the ordered list need not indicate to which organizations the obfuscated KPIs 170-174 correspond, thus maintaining privacy of organization data.

Still, the present arrangements can be applied to any other type of performance metrics and the present arrangements are not limited in this regard. Moreover, the present arrangements are not limited to the manner in which organizations use the KPI average value 180 received from the KPI server application 140.

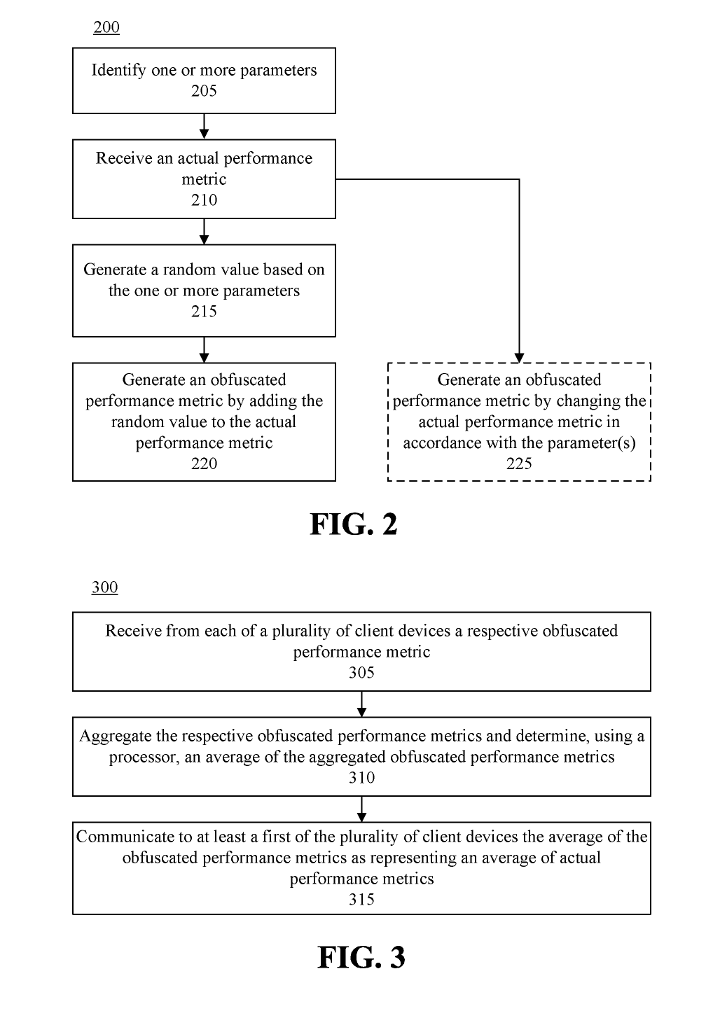

FIG. 2 is a flowchart illustrating an example of a process 200 implemented by an executable function to generate an obfuscated performance metric. At step 205, the executable function can identify one or more parameters. At step 210, the executable function can receive an actual performance metric. At step 215, the executable function can generate a random value based on the one or more parameters. At step 220, the executable function can generate an obfuscated performance metric by adding the random value to the actual performance metric.

In another arrangement, rather than performing steps 215 and 220, at step 225 the executable function can generate an obfuscated performance metric by changing the actual performance metric in accordance with the parameter(s). For example, the executable function can scale the actual performance metric in accordance with the parameter(s).

FIG. 3 is a flowchart illustrating an example of a method 300 of communicating to at least one client device an average of obfuscated performance metrics. At step 305, a performance metrics server can receive from each of a plurality of client devices a respective obfuscated performance metric. At step 310, the performance metrics server can aggregate the respective obfuscated performance metrics and determine, using a processor, an average of the aggregated obfuscated performance metrics. At step 315, the performance metrics server can communicate to at least a first of the plurality of client devices the average of the obfuscated performance metrics as representing an average of actual performance metrics.

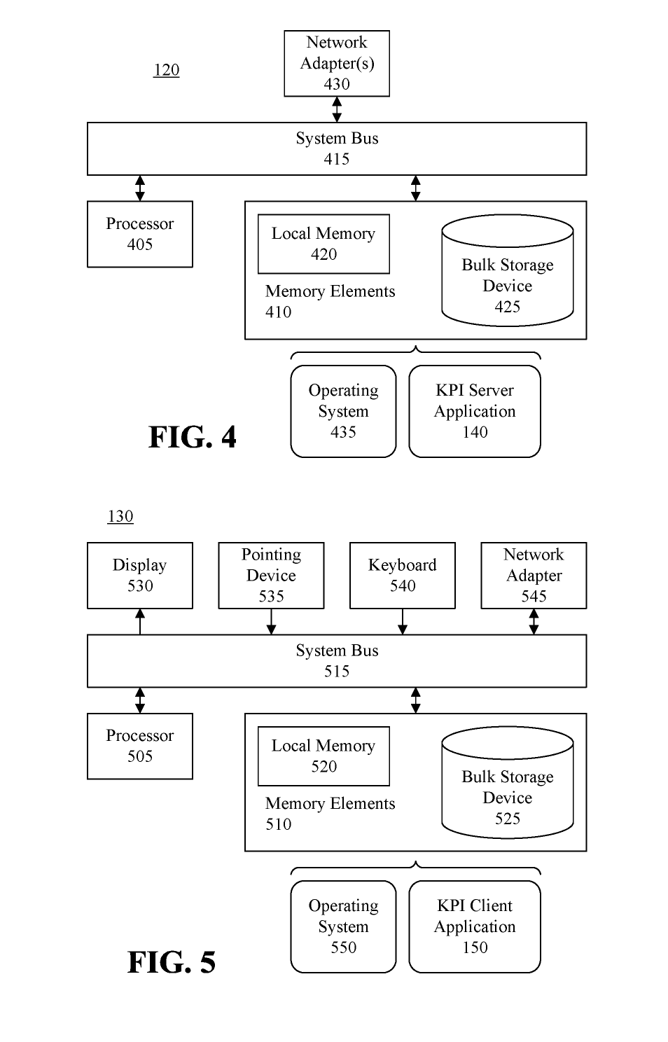

FIG. 4 is a block diagram illustrating an example architecture for the performance metrics system 120 of FIG. 1. The performance metrics system 120 can include at least one processor 405 (e.g., a central processing unit) coupled to memory elements 410 through a system bus 415 or other suitable circuitry. As such, the performance metrics system 120 can store program code within the memory elements 410. The processor 405 can execute the program code accessed from the memory elements 410 via the system bus 415. It should be appreciated that the performance metrics system 120 can be implemented in the form of any system including a processor and memory that is capable of performing the functions and/or operations described within this specification that are performed by the performance metrics system 120. For example, the performance metrics system 120 can be implemented as one or more hardware servers.

The memory elements 410 can include one or more physical memory devices such as, for example, local memory 420 and one or more bulk storage devices 425. Local memory 420 refers to random access memory (RAM) or other non-persistent memory device(s) generally used during actual execution of the program code. The bulk storage device(s) 425 can be implemented as a hard disk drive (HDD), solid state drive (SSD), or other persistent data storage device. The performance metrics system 120 also can include one or more cache memories (not shown) that provide temporary storage of at least some program code in order to reduce the number of times program code must be retrieved from the bulk storage device 425 during execution.

One or more network adapters 430 can be coupled to performance metrics system 120 to enable the performance metrics system 120 to become coupled to other systems, client devices, computer systems, remote printers, and/or remote storage devices through intervening private or public networks. Modems, cable modems, transceivers, and Ethernet cards are examples of different types of network adapters 430 that can be used with the performance metrics system 120.

As pictured in FIG. 4, the memory elements 410 can store components of the performance metrics system 120, for example an operating system 435 and the KPI server application 140 depicted in FIG. 1. Being implemented in the form of executable program code, the operating system 435 and the KPI server application 140 can be executed by the processor 405. For example, the processor 405 can execute the KPI server application 140 within a computing environment provided by the operating system 435 in order to perform the processes described herein that are performed by the performance metrics system 120. As such, the operating system 435 and the KPI server application 140 can be considered part of the performance metrics system 120. Moreover, the operating system 435 and the KPI server application 140 are functional data structures that impart functionality when employed as part of the performance metrics system 120.

FIG. 5 is a block diagram illustrating an example architecture for the client device 130 of FIG. 1. The client devices 132, 134 can include similar architecture. The client device 130 can include at least one processor 505 (e.g., a central processing unit) coupled to memory elements 510 through a system bus 515 or other suitable circuitry. As such, the client device 130 can store program code within the memory elements 510. The processor 505 can execute the program code accessed from the memory elements 510 via the system bus 515. It should be appreciated that the client device 130 can be implemented in the form of any system including a processor and memory that is capable of performing the functions and/or operations described within this specification that are performed by the client device 130.

The memory elements 510 can include one or more physical memory devices such as, for example, local memory 520 and one or more bulk storage devices 525. The client device 130 also can include one or more cache memories (not shown) that provide temporary storage of at least some program code in order to reduce the number of times program code must be retrieved from the bulk storage device 525 during execution.

Input/output (I/O) devices such as a display 530, a pointing device 535 and, optionally, a keyboard 540 can be coupled to the client device 130. The I/O devices can be coupled to the client device 130 either directly or through intervening I/O controllers. For example, the display 530 can be coupled to the client device 130 via a graphics processing unit (GPU), which may be a component of the processor 505 or a discrete device. At least one network adapter 545 also can be coupled to client device 130 to enable the client device 130 to become coupled to other systems, computer systems, remote printers, and/or remote storage devices through intervening private or public networks.

As pictured in FIG. 5, the memory elements 510 can store the components of the client device 130, for example an operating system 550 and the KPI client application 150 of FIG. 1. Being implemented in the form of executable program code, the operating system 550 and the KPI client application 150 can be executed by the processor 505. For example, the processor 505 can execute the KPI client application 150 within a computing environment provided by the operating system 550 in order to perform the processes described herein that are performed by the client device 130. As such, the operating system 550 and the KPI client application 150 can be considered part of the client device 130. Moreover, the operating system 550 and the KPI client application 150 are functional data structures that impart functionality when employed as part of the client device 130.

While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes,” “including,” “comprises,” and/or “comprising,” when used in this disclosure, specify the presence of stated features, integers, steps, operations, elements, and/or components, but do not preclude the presence or addition of one or more other features, integers, steps, operations, elements, components, and/or groups thereof.

Reference throughout this disclosure to “one embodiment,” “an embodiment,” or similar language means that a particular feature, structure, or characteristic described in connection with the embodiment is included in at least one embodiment described within this disclosure. Thus, appearances of the phrases “in one embodiment,” “in an embodiment,” and similar language throughout this disclosure may, but do not necessarily, all refer to the same embodiment.

The term “plurality,” as used herein, is defined as two or more than two. The term “another,” as used herein, is defined as at least a second or more. The term “coupled,” as used herein, is defined as connected, whether directly without any intervening elements or indirectly with one or more intervening elements, unless otherwise indicated. Two elements also can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, etc. may be used herein to describe various elements, these elements should not be limited by these terms, as these terms are only used to distinguish one element from another unless stated otherwise or the context indicates otherwise.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
receiving from each of a plurality of client devices a respective obfuscated performance metric;
aggregating the respective obfuscated performance metrics and determining, using a processor, an average of the aggregated obfuscated performance metrics; and
communicating to at least a first of the plurality of client devices the average of the obfuscated performance metrics as representing an average of actual performance metrics.

2. The method of claim 1, wherein each respective obfuscated performance metric is an obfuscated key performance indicator.

3. The method of claim 1, wherein:
each of the plurality of client devices generates the respective obfuscated performance metric by processing a respective actual performance metric; and
each obfuscated performance metric has a value within a particular variance of the respective actual performance metric that is processed to generate the respective obfuscated performance metric.

4. The method of claim 3, further comprising:
communicating to the first of the plurality of client devices a plurality of parameters that define a random noise vector from a Gaussian distribution;
wherein the first of the plurality of client devices generates the respective obfuscated performance metric by processing the plurality of parameters to generate a random value and adding the random value to the respective actual performance metric.

5. The method of claim 3, further comprising:
communicating to the first of the plurality of client devices a plurality of parameters;
wherein the first of the plurality of client devices randomly selects at least one of the plurality of parameters and generates the respective obfuscated performance metric by processing the respective actual performance metric using the randomly selected at least one of the plurality of parameters.

6. The method of claim 3, further comprising:
communicating to the first of the plurality of client devices a plurality of executable functions;
wherein the first of the plurality of client devices randomly selects at least one of the plurality of executable functions and generates the respective obfuscated performance metric by processing the respective actual performance metric using the randomly selected at least one of the plurality of executable functions.

7. The method of claim 1, further comprising:
communicating, to each of the plurality of client devices, a client application used to generate the respective obfuscated performance metrics.

8. A system, comprising:
a processor programmed to initiate executable operations comprising:
receiving from each of a plurality of client devices a respective obfuscated performance metric;
aggregating the respective obfuscated performance metrics and determining an average of the aggregated obfuscated performance metrics; and
communicating to at least a first of the plurality of client devices the average of the obfuscated performance metrics as representing an average of actual performance metrics.

9. The system of claim 8, wherein each respective obfuscated performance metric is an obfuscated key performance indicator.

10. The system of claim 8, wherein:
each of the plurality of client devices generates the respective obfuscated performance metric by processing a respective actual performance metric; and
each obfuscated performance metric has a value within a particular variance of the respective actual performance metric that is processed to generate the respective obfuscated performance metric.

11. The system of claim 10, the executable operations further comprising:
communicating to the first of the plurality of client devices a plurality of parameters that define a random noise vector from a Gaussian distribution;
wherein the first of the plurality of client devices generates the respective obfuscated performance metric by processing the plurality of parameters to generate a random value and adding the random value to the respective actual performance metric.

12. The system of claim 10, the executable operations further comprising:
communicating to the first of the plurality of client devices a plurality of parameters;
wherein the first of the plurality of client devices randomly selects at least one of the plurality of parameters and generates the respective obfuscated performance metric by processing the respective actual performance metric using the randomly selected at least one of the plurality of parameters.

13. The system of claim 10, the executable operations further comprising:
communicating to the first of the plurality of client devices a plurality of executable functions;
wherein the first of the plurality of client devices randomly selects at least one of the plurality of executable functions and generates the respective obfuscated performance metric by processing the respective actual performance metric using the randomly selected at least one of the plurality of executable functions.

14. The system of claim 8, the executable operations further comprising:
communicating, to each of the plurality of client devices, a client application used to generate the respective obfuscated performance metrics.

15. A computer program product comprising a computer readable storage medium having program code stored thereon, the program code executable by a processor to perform a method comprising:
receiving, by the processor, from each of a plurality of client devices a respective obfuscated performance metric;
aggregating, by the processor, the respective obfuscated performance metrics and determining, by the processor, an average of the aggregated obfuscated performance metrics; and
communicating, by the processor, to at least a first of the plurality of client devices the average of the obfuscated performance metrics as representing an average of actual performance metrics.

16. The computer program product of claim 15, wherein each respective obfuscated performance metric is an obfuscated key performance indicator.

17. The computer program product of claim 15, wherein:
each of the plurality of client devices generates the respective obfuscated performance metric by processing a respective actual performance metric; and
each obfuscated performance metric has a value within a particular variance of the respective actual performance metric that is processed to generate the respective obfuscated performance metric.

18. The computer program product of claim 17, the method further comprising:
communicating to the first of the plurality of client devices a plurality of parameters that define a random noise vector from a Gaussian distribution;
wherein the first of the plurality of client devices generates the respective obfuscated performance metric by processing the plurality of parameters to generate a random value and adding the random value to the respective actual performance metric.

19. The computer program product of claim 17, the method further comprising:
communicating to the first of the plurality of client devices a plurality of parameters;
wherein the first of the plurality of client devices randomly selects at least one of the plurality of parameters and generates the respective obfuscated performance metric by processing the respective actual performance metric using the randomly selected at least one of the plurality of parameters.

20. The computer program product of claim 17, the method further comprising:
communicating to the first of the plurality of client devices a plurality of executable functions;
wherein the first of the plurality of client devices randomly selects at least one of the plurality of executable functions and generates the respective obfuscated performance metric by processing the respective actual performance metric using the randomly selected at least one of the plurality of executable functions.
